(19) United States
(12) Patent Application Publication
(10) Pub. No.: US 2026/0155402 A1
(43) Pub. Date: Jun. 4, 2026

(54) FUEL CELL

(71) Applicant: TOYOTA JIDOSHA KABUSHIKI KAISHA, Toyota-shi (JP)

(72) Inventors: Kohei IKEDA, Anjo-shi (JP); Kotaro IKEDA, Susono-shi (JP); Yoshihira IKOGI, Neyagawa-shi (JP)

(73) Assignee: TOYOTA JIDOSHA KABUSHIKI KAISHA, Toyota-shi (JP)

(21) Appl. No.: 19/400,484

(22) Filed: Nov. 25, 2025

(30) Foreign Application Priority Data
Nov. 29, 2024 (JP) 2024-207840

(51) Int. Cl. H01M 8/026; H01M 8/0232; H01M 8/10; H01M 8/1004

(52) U.S. Cl. CPC H01M 8/026; H01M 8/0232; H01M 8/1004; H01M 2008/1095

(57) ABSTRACT

A fuel cell for generating power through reaction of a reaction gas comprises: a membrane electrode assembly including an electrolyte membrane and a catalyst layer; a gas diffusion layer stacked on the membrane electrode assembly and composed of a metal porous body; and a separator having a plate shape, and being parallel to a plane direction of the membrane electrode assembly. The gas diffusion layer has a groove through which the reaction gas flows on a surface facing the separator.

### CROSS REFERENCE TO RELATED APPLICATIONS

The present application claims priority from Japanese Patent Application No. 2024-207840 filed on Nov. 29, 2024, the disclosure of which is hereby incorporated in its entirety by reference into the present application.

### BACKGROUND

### Field

The present disclosure relates to a fuel cell.

### Related Art

Various techniques have been suggested in relation to a layer structure of a fuel cell. As an example, Japanese Patent Application Publication No. 2002-289223 discloses a technique by which a surface of a separator on the side of a catalyst layer is provided with a plurality of grooves. These grooves are used as a flow path for a reaction gas. In order to supply the reaction gas more efficiently to the catalyst layer, the inventors of considered using a gas diffusion layer composed of a porous body between the catalyst layer and the separator.

In the fuel cell having the separator where the flow path is formed and the gas diffusion layer, thinning the gas diffusion layer for size reduction of the fuel cell leads to the following issues. Specifically, the cross-sectional area perpendicular to the gas flow direction in the region where the reaction gas flows within the gas diffusion layer decreases. Consequently, the pressure loss of the reaction gas increases. This makes it difficult for the reaction gas to spread over an entire surface of the catalyst layer to cause a risk of reduction in power generation efficiency.

### SUMMARY

The present disclosure is feasible in the following aspects.

According to one aspect of the present disclosure, a fuel cell for generating power through reaction of a reaction gas is provided. The fuel cell comprises: a membrane electrode assembly including an electrolyte membrane and a catalyst layer; a gas diffusion layer stacked on the membrane electrode assembly and composed of a metal porous body; and a separator having a plate shape, being parallel to a plane direction of the membrane electrode assembly, and being stacked on the gas diffusion layer. The gas diffusion layer has a groove through which the reaction gas flows on a surface facing the separator.

### BRIEF DESCRIPTION OF THE DRAWINGS

FIG. 1 is a plan view of a fuel cell according to one embodiment of the present disclosure;

FIG. 2 is a view showing a section cut along a line II-II in FIG. 1;

FIG. 3 is a sectional view of a fuel cell according to a comparative example;

FIG. 4 is a view for explaining a fuel cell according to a second embodiment; and

FIG. 5 is a view for explaining a fuel cell according to a third embodiment.

### DETAILED DESCRIPTION

### A. First Embodiment

### A1. Configuration of Fuel Cell 100

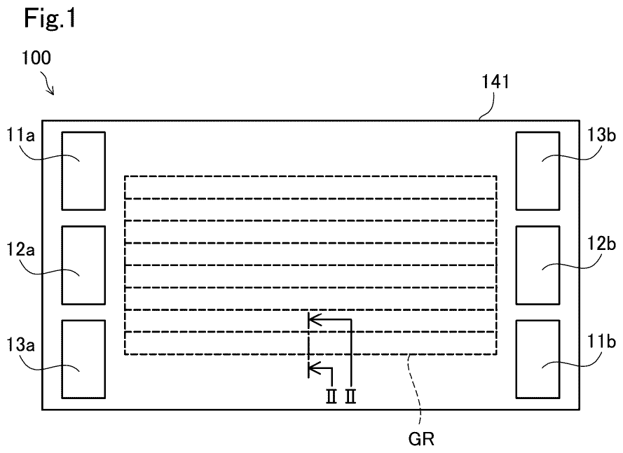

FIG. 1 is a plan view of a fuel cell 100 according to one embodiment of the present disclosure. FIG. 1 shows the fuel cell 100 viewed from the side of a cathode-side separator 141 described later. The fuel cell 100 has a rectangular appearance shape viewed in a thickness direction. The fuel cell 100 generates power through reaction of a reaction gas. In the present embodiment, the reaction gas includes hydrogen gas as a fuel gas and air as an oxidizing gas. By stacking a plurality of the fuel cells 100 to form a stack thereof, these fuel cells 100 are used in a driving power source in an electric vehicle, for example.

The fuel cell 100 is provided with oxidizing gas manifolds 11a and 11b, cooling medium manifolds 12a and 12b, and fuel gas manifolds 13a and 13b. The oxidizing gas manifold 11a is used for supplying the oxidizing gas to the fuel cell 100. The oxidizing gas manifold 11b is used for discharging the oxidizing gas from the fuel cell 100. The cooling medium manifold 12a is used for supplying a cooling medium to the fuel cell 100. The cooling medium manifold 12b is used for discharging the cooling medium from the fuel cell 100. The fuel gas manifold 13a is used for supplying the fuel gas to the fuel cell 100. The fuel gas manifold 13b is used for discharging the fuel gas from the fuel cell 100. The reaction gas starts from the manifold 11a or 13a for supply, passes through grooves GR, and then reaches the manifold 11b or 13b for discharge.

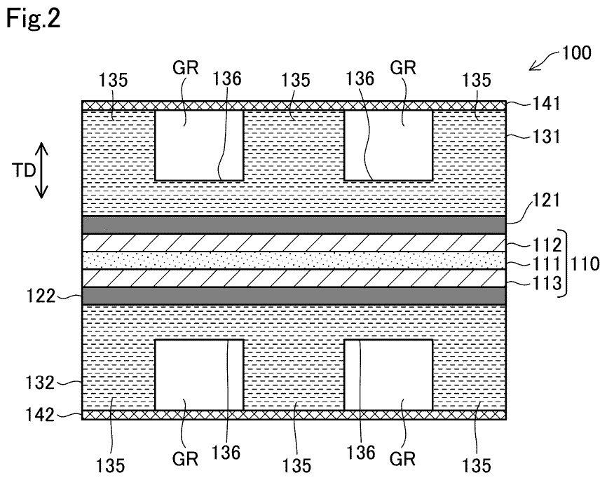

FIG. 2 is a view showing a section cut along a line II-II in FIG. 1. The fuel cell 100 includes a membrane electrode assembly 110, water-repellent layers 121 and 122, gas diffusion layers 131 and 132, the cathode-side separator 141, and an anode-side separator 142. In some cases below, a side where the cathode-side separator 141 is present will be called a “cathode side” and a side where the anode-side separator 142 is present will be called an “anode side.”

### Configuration of Membrane Electrode Assembly 110

The membrane electrode assembly 110 has a plate-like appearance shape viewed in a thickness direction TD. The membrane electrode assembly 110 includes an electrolyte membrane 111, a cathode-side catalyst layer 112, and an anode-side catalyst layer 113. The electrolyte membrane 111 carries protons generated on the anode side to the cathode side. The electrolyte membrane 111 is a solid polymer membrane, and is a proton-conducting ion-exchange membrane composed of a fluorine resin such as a perfluorocarbon sulfonic acid polymer, for example. The cathode-side catalyst layer 112 is stacked on one surface of the electrolyte membrane 111. The cathode-side catalyst layer 112 catalyzes a reduction reaction of the oxidizing gas. The anode-side catalyst layer 113 catalyzes an oxidation reaction of the fuel gas. The cathode-side catalyst layer 112 and the anode-side catalyst layer 113 are each composed of carbon particles supporting a catalyst metal such as platinum, for example. The anode-side catalyst layer 113 is stacked on the other surface of the electrolyte membrane 111.

In the present disclosure, “being stacked” means not only a state where members are overlaid on each other with direct contact therebetween but also a state where a different member is interposed between these members. In the present disclosure, the cathode-side catalyst layer 112 and the anode-side catalyst layer 113 are also called a “catalyst layer” collectively.

### Configuration of Water-Repellent Layers 121, 122

The water-repellent layers 121 and 122 each have a plate-like appearance shape viewed in the thickness direction TD. The water-repellent layers 121 and 122 are stacked on surfaces of the catalyst layers 112 and 113 respectively opposite to surfaces thereof in contact with the electrolyte membrane 111. The water-repellent layers 121 and 122 discharge water generated by the reduction reaction of the oxidizing gas to the gas diffusion layers 131 and 132. The water-repellent layers 121 and 122 transmit electrons from the membrane electrode assembly 110 to the gas diffusion layers 131 and 132. The water-repellent layers 121 and 122 each contain conductive carbon particles and a water repellent agent. The water repellent agent is a fluorine resin such as polytetrafluoroethylene, for example.

### Configuration of Gas Diffusion Layers 131, 132

The gas diffusion layers 131 and 132 are stacked on surfaces of the water-repellent layers 121 and 122 respectively opposite to surfaces thereof in contact with the membrane electrode assembly 110. The thickness of the gas diffusion layers 131 and 132 is, for example, 0.2 mm to 0.5 mm. The gas diffusion layers 131 and 132 supply the reaction gas uniformly to the membrane electrode assembly 110 to encourage power generation. The gas diffusion layers 131 and 132 transmit electrons from the water-repellent layers 121 and 122 respectively to the cathode-side separator 141 and the anode-side separator 142 respectively.

In the present disclosure, the gas diffusion layers 131 and 132 are each composed of a metal porous body. The metal porous body is prepared by foaming metal such as aluminum, nickel, titanium, or stainless steel, for example. The metal porous body possesses multiple pores. The pores are interconnected. The reaction gas flows through the pores. In the present disclosure, the gas diffusion layers 131 and 132 have a plurality of the grooves GR on surfaces facing and in contact with the cathode-side separator 141 and the anode-side separator 142 respectively. The grooves GR are formed by cutting or laser machining, for example. The reaction gas flows through the grooves GR. More specifically, the oxidizing gas flows in space defined by the grooves GR and the cathode-side separator 141. The fuel gas flows in space defined by the grooves GR and the anode-side separator 142. As shown in FIG. 1, all the grooves GR extend in a lengthwise direction of the fuel cell 100 and are provided parallel to each other. For this reason, FIG. 2 may also be said to be a view showing a section cut in a direction vertical to the flow direction of the reaction gas.

As shown in FIG. 2, in the present embodiment, each groove GR is formed into a rectangular shape in the cross-section of the gas diffusion layer 131 and 132 perpendicular to a direction in which the reaction gas flows. In other words, the gas diffusion layer 131 has a configuration with projections 135 and recesses 136 provided alternately and continuously. The projections 135 project toward the cathode-side separator 141 or the anode-side separator 142, and are in contact with the cathode-side separator 141 or the anode-side separator 142. A surface of each projection 135 in contact with the cathode-side separator 141 or the anode-side separator 142 is parallel to the cathode-side separator 141 and the anode-side separator 142. It may also be said that each projection 135 forms a side surface of a corresponding one of the grooves GR. The recesses 136 are depressed toward the membrane electrode assembly 110. It may also be said that each recess 136 forms a bottom surface of a corresponding one of the grooves GR. The width of each projection 135 is from 0.2 to 0.8 mm, for example. The width of each recess 136 is from 0.2 to 0.8 mm, for example. The height of each projection 135 is from 0.2 to 0.8 mm, for example.

### Configurations of Cathode-Side Separator 141 and Anode-Side Separator 142

In the following, if the cathode-side separator 141 and the anode-side separator 142 will not to be distinguished from each other, the cathode-side separator 141 and the anode-side separator 142 will also be called “separators” collectively. The separators 141 and 142 have a plate-like appearance shape. The separators 141 and 142 are parallel to a plane direction of the membrane electrode assembly 110. The separators 141 and 142 are stacked on surfaces of the gas diffusion layers 131 and 132 respectively opposite to surfaces thereof in contact with the water-repellent layers 121 and 122 respectively. The thickness of the separators 141 and 142 is, for example, 0.05 mm to 0.2 mm. The separators 141 and 142 are thinner than the gas diffusion layers 131 and 132. The separators 141 and 142 receive electrons transmitted from the gas diffusion layers 131 and 132. The separators 141 and 142 are in contact with the projections 135 along respective surfaces of the separators 141 and 142 on the sides of the gas diffusion layers 131 and 132 respectively. Specifically, loads on the separators 141 and 142 are also applied to the projections 135.

### Comparison From Fuel Cell 500 According to Comparative Example

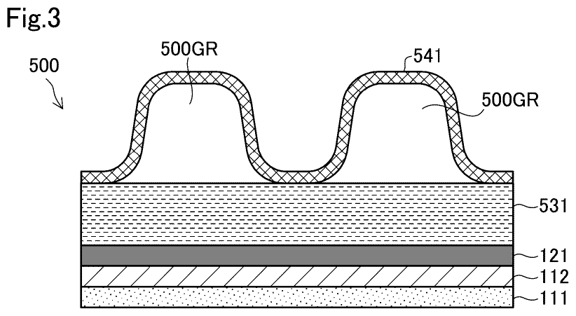

FIG. 3 is a sectional view of a fuel cell 500 according to a comparative example. Like FIG. 2, FIG. 3 shows a section of the fuel cell 500 cut in the direction vertical to the flow direction of the reaction gas. FIG. 3 only shows a configuration on the cathode side and a configuration on the anode side is omitted therefrom. In the comparative example, the configuration on the anode side is similar to the configuration on the cathode side. In the fuel cell 500 of the comparative example, the configurations of a gas diffusion layer 531 and a separator 541 are different from the corresponding configurations of the embodiment described above. The other configurations are the same as those of the fuel cell 100 of the embodiment, so that these configurations will be given the same signs and will not be described.

The gas diffusion layer 531 has a plate-like appearance shape viewed in the thickness direction TD. The gas diffusion layer 531 has a flat surface. Specifically, unlike the gas diffusion layers 131 and 132 of the embodiment, the gas diffusion layer 531 is not provided with grooves.

The separator 541 is prepared by bending a flat plate several times. The separator 541 has a plurality of grooves 500GR. The reaction gas flows through the grooves 500GR. More specifically, the reaction gas flows in space defined by the grooves 500GR and the gas diffusion layer 531.

As the grooves 500GR of the comparative example are provided at the separator 541, it is difficult to form the fuel cell into a small thickness while ensuring the depths of the grooves 500GR and the thickness of the gas diffusion layer 531. Moreover, the reaction gas is to flow a comparatively large distance from the grooves 500GR to the membrane electrode assembly 110. This results in insufficient supply of the reaction gas to the membrane electrode assembly 110, causing a risk of reduction in power generation efficiency in the fuel cell 500.

By contrast, in the fuel cell 100 of the embodiment shown in FIG. 2, the grooves GR through which the reaction gas flows are provided at the gas diffusion layers 131 and 132. This allows the fuel cell 100 to be formed into a small thickness while ensuring the depths of the grooves GR and the thicknesses of the gas diffusion layers 131 and 132, compared to the configuration of the comparative example where the grooves 500GR are provided at the separator 541. Moreover, it is possible to shorten a route for the reaction gas to reach the membrane electrode assembly 110. This achieves improved power generation efficiency in the fuel cell 100.

The fuel cell 100 of the first embodiment described above includes the separators 141 and 142 parallel to the plane direction of the membrane electrode assembly 110, and the gas diffusion layer 131 having the grooves GR through which the reaction gas flows on a surface facing the separator 141 or 142. This allows the thickness of the entire fuel cell 100 to be reduced while ensuring the thicknesses of the gas diffusion layers 131 and 132, compared to the configuration where the grooves 500GR are provided at the separator 541. Specifically, when forming the grooves 500GR in the separator 541, the grooves 500GR are formed by bending the separator 541, which is thinner than the gas diffusion layers 131 and 132. Therefore, it is difficult to achieve thinness while ensuring the grooves 500GR. In contrast, when forming the grooves GR in the gas diffusion layer 131, the grooves GR are formed by machining gas diffusion layer 131. Therefore, compared to the configuration where the grooves 500GR is formed by bending the separator 541, the overall thickness of fuel cell 100 can be reduced. Therefore, it is possible to form the fuel cell 100 into a small thickness while suppressing pressure loss at the gas diffusion layers 131 and 132. It is further possible to shorten distances between the grooves GR and catalyst layers 112 and 113, thereby achieving improved efficiency in supplying the reaction gas.

In the fuel cell 100 of the first embodiment, the grooves GR are provided at the gas diffusion layers 131 and 132. This allows the grooves GR to be formed with a comparatively small interval therebetween while ensuring contact areas between the separators 141 and 142 and the gas diffusion layers 131 and 132, compared to the configuration where the grooves 500GR are provided at the separator 541. More specifically, if the grooves 500GR are to be provided at the separator 541, the grooves 500GR are formed by press working, for example. In doing this, trying to reduce an interval between the adjacent grooves 500GR makes the separator 541 pointed sharply between the adjacent grooves 500GR to reduce a contact area between the separator 541 and the gas diffusion layer 531. This results in application of local pressure to the gas diffusion layer 531, causing a risk of reduction in power generation performance and durability.

By contrast, if the grooves GR are to be provided at the gas diffusion layers 131 and 132 like in the fuel cell 100 of the first embodiment, the grooves GR are formed by cutting or laser machining on the metal porous bodies. Specifically, it is possible to form the grooves GR with a small interval therebetween while maintaining the flat shapes of the projections 135. This allows the grooves GR to be formed with a small interval therebetween while ensuring contact areas between the separators 141 and 142 and the gas diffusion layers 131 and 132.

In the fuel cell 100 of the first embodiment, the gas diffusion layers 131 and 132 are composed of the metal porous bodies. This allows the gas diffusion layers 131 and 132 to have increased rigidity, compared to a configuration where a gas diffusion layer is formed using a porous body composed only of a material other than metal that such as carbon, for example. Thus, even if comparatively high pressure is applied in the thickness direction TD to the gas diffusion layer 131 or 132, it is still possible to reduce the occurrence of break of the gas diffusion layer 131 or 132. As a metallic material is generally lower in electrical resistance than carbon, it is possible to improve conductive property, compared to the configuration where the gas diffusion layers 131 and 132 are composed of carbon.

In the fuel cell 100 of the first embodiment, each groove GR is formed into a rectangular shape in the cross-section of the gas diffusion layer 131 and 132 perpendicular to a direction in which the reaction gas flows. Thus, compared to a configuration where grooves are formed into a sinusoidal wave shape, for example, it is possible to increase contact areas with the separators 141 and 142 while ensuring the sectional areas of the grooves GR. As a result, even if pressure is applied in the thickness direction TD of the fuel cell 100, it is still possible to reduce application of local pressure to the gas diffusion layer 131 or 132, thereby reducing the occurrence of break of the fuel cell 100 or reduction in power generation performance.

### B. Second Embodiment

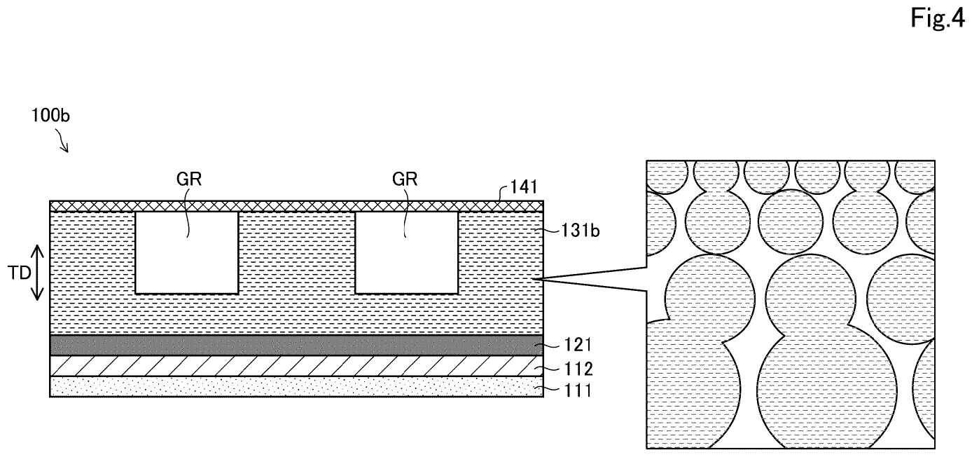

FIG. 4 is a view for explaining a fuel cell 100b according to a second embodiment. Like FIG. 2, FIG. 4 shows a section of the fuel cell 100b cut in the direction vertical to the flow direction of the reaction gas. FIG. 4 only shows the cathode side and the anode side is omitted therefrom. In the fuel cell 100b of the second embodiment, the configuration of a gas diffusion layer 131b is different from the corresponding configuration in the fuel cell 100 of the first embodiment. The other configurations are the same as those of the fuel cell 100 of the first embodiment, so that these configurations will not be described.

A pore-diameter distribution in the gas diffusion layer 131b is schematically shown in the right section of FIG. 4. In the present embodiment, the gas diffusion layer 131b has such a pore-diameter distribution in the thickness direction TD as to make a pore diameter on a side farther from the membrane electrode assembly 110 smaller than that on a side closer to the membrane electrode assembly 110. In other words, the gas diffusion layer 131b has two portions positioned at different locations along a thickness direction TD of the gas diffusion layer 131b. Each of two portions has pores. One portion of the two portions farther from the membrane electrode assembly 110 than the other portion of the two portions has pores with a smaller diameter than the other portion. The described gas diffusion layer 131b is formed by sequentially stacking a first layer composed of metallic powder having comparatively large pores, a second layer composed of metallic powder having smaller pores than those in the first layer, and a third layer composed of metallic powder having smaller pores than those in the second layer, for example. The gas diffusion layer 131b may be formed by an arbitrary method not limited to the foregoing method. The pore-diameter distribution may be determined by a mercury intrusion method, for example.

Note here that the above configuration may be provided not only at the gas diffusion layer 131b on the cathode side but also at the gas diffusion layer 132 on the anode side. In another case, the above configuration may be provided only at the gas diffusion layer 132 on the anode side.

In the fuel cell 100b of the second embodiment described above, the gas diffusion layer 131b has two portions positioned at different locations along a thickness direction TD of the gas diffusion layer 131b. Each of two portions has pores. One portion of the two portions farther from the membrane electrode assembly 110 than the other portion of the two portions has pores with a smaller diameter than the other portion. Thus, water present in the gas diffusion layer 131b composed of a metal porous body that is generally hydrophilic is allowed to be discharged easily from the side closer to the membrane electrode assembly 110 toward the side farther from the membrane electrode assembly 110. More specifically, in a portion in the gas diffusion layer 131b where a pore diameter is comparatively small, a distance between metallic particles is comparatively short to cause force of attracting water to act comparatively strongly. This allows the water to be attracted toward the side in the gas diffusion layer 131b farther from the membrane electrode assembly 110, thereby improving water discharge performance in the gas diffusion layer 131b.

### C. Third Embodiment

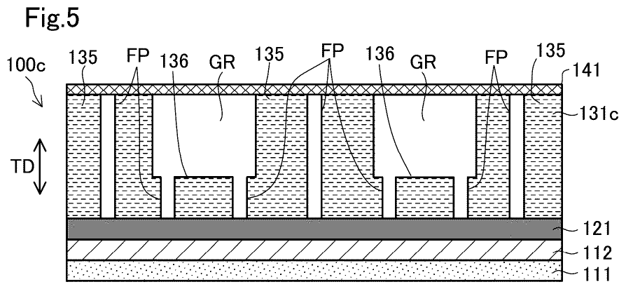

FIG. 5 is a view for explaining a fuel cell 100c according to a third embodiment. Like FIG. 2, FIG. 5 shows a section of the fuel cell 100c cut in the direction vertical to the flow direction of the reaction gas. FIG. 5 only shows the cathode side and the anode side is omitted therefrom. In the fuel cell 100c of the third embodiment, the configuration of a gas diffusion layer 131c is different from the corresponding configuration in the fuel cell 100 of the first embodiment. The other configurations are the same as those of the fuel cell 100 of the first embodiment, so that these configurations will not be described.

As shown in FIG. 5, the gas diffusion layer 131c has through flow paths FP penetrating the gas diffusion layer 131c in the thickness direction TD. The reaction gas flows through the through flow paths FP.. The diameter of the through flow paths FP is, for example, 0.1 mm. In the present embodiment, the through flow paths FP are provided both at the projections 135 and the recesses 136. The through flow paths FP are through holes formed in the thickness direction TD in the gas diffusion layer 131c. The reaction gas is supplied through the through flow paths FP toward the membrane electrode assembly 110.

The above configuration may be provided not only at the gas diffusion layer 131c on the cathode side but also at the gas diffusion layer 132 on the anode side. In another case, the above configuration may be provided only at the gas diffusion layer 132 on the anode side. The fuel cell 100c of the third embodiment may be used in combination with the fuel cell 100b of the second embodiment.

In the fuel cell 100c of the third embodiment described above, the gas diffusion layer 131c has the through flow paths FP penetrating the gas diffusion layer 131c in the thickness direction TD and allowing the reaction gas to flow. This allows the reaction gas to be supplied toward the membrane electrode assembly 110 via the through flow paths FP. Thus, even if water is present in the gas diffusion layer 131c, it is still possible to ensure a route for the reaction gas to suppress reduction in efficiency in supplying the reaction gas.

### D. Other Embodiments

(D1) In the above-described embodiments, each of the grooves GR is formed into a rectangular shape taken along the sections of the gas diffusion layers 131 and 132 cut in the direction vertical to the flow direction of the reaction gas. However, the present disclosure is not limited to this. Each groove GR may have an arbitrary shape. Even in such a configuration, the provision of the grooves GR at the gas diffusion layers 131 and 132 still allows the thickness of the entire fuel cell 100 to be reduced while ensuring the thicknesses of the gas diffusion layers 131 and 132, compared to the configuration where grooves are provided at the separators 141 and 142.
(D2) In each of the above-described embodiments, the water-repellent layers 121 and 122 are omissible from the fuel cell 100, 100b, or 100c.
(D3) In each of the above-described embodiments, all the grooves GR extend in the lengthwise direction of the fuel cell 100 and are provided parallel to each other, as shown in FIG. 1. However, the present disclosure is not limited to this. Each of the grooves GR may be formed into an arbitrary shape viewed in the thickness direction TD of the fuel cell 100. Each of the grooves GR may be formed in a meandering pattern, for example. Alternatively, in one configuration, only one groove GR may be provided instead of the plurality of grooves GR. In such a configuration, the one groove GR may form a so-called serpentine flow path extending back and forth in a meandering pattern in a region between the manifolds 11a and 13a on the supply side of the reaction gas and the manifolds 11b and 13b on the discharge side of the reaction gas.
(D4) In each of the above-described embodiments, parts of the separators 141 and 142 in contact with the projections 135 may be formed thicker than the other parts thereof. In such a configuration, it is possible to increase rigidity in parts of the separators 141 and 142 to which local loads are to be applied when a load is applied to the fuel cell 100, 100b, or 100c in the thickness direction TD.
(D5) In each of the above-described embodiments, the fuel cell 100, 100b, or 100c may be used as a water electrolysis cell.
(D6) In the above-described first embodiment, the grooves GR are formed both at the cathode-side gas diffusion layer 131 and the anode-side gas diffusion layer 132. However, the present disclosure is not limited to this. The grooves GR may be provided only at one of the gas diffusion layers 131 and 132.
(D7) In the above-described second embodiment, a void ratio in the gas diffusion layer 131b may be smaller on a side farther from the membrane electrode assembly 110 than on a side closer to the membrane electrode assembly 110 in the thickness direction TD. The void ratio may be measured by an Archimedean method, a mercury porosity method, or the like for example.
(D8) In the above-described third embodiment, the through flow paths FP are provided both at the projections 135 and the recesses 136. However, the present disclosure is not limited to this. The through flow paths FP may be provided only at one of the projections 135 and the recesses 136.

The present disclosure is not limited to the embodiments described above and is able to be realized with various configurations without departing from the spirit thereof. For example, the technical features in the embodiments are able to be replaced with each other or combined together, as appropriate, in order to solve part or the whole of the problems described previously or to achieve part or the whole of the effects described previously. When the technical features are not described as essential features in the present specification, they are able to be deleted, as appropriate. The present disclosure may be realized in the following aspects, for example.
(1) According to one aspect of the present disclosure, a fuel cell for generating power through reaction of a reaction gas is provided. The fuel cell comprises: a membrane electrode assembly including an electrolyte membrane and a catalyst layer; a gas diffusion layer stacked on the membrane electrode assembly and composed of a metal porous body; and a separator having a plate shape, being parallel to a plane direction of the membrane electrode assembly, and being stacked on the gas diffusion layer. The gas diffusion layer has a groove through which the reaction gas flows on a surface facing the separator.

The fuel cell of this aspect includes the separator having a plate shape and being parallel to the plane direction of the membrane electrode assembly, and the gas diffusion layer having the groove through which the reaction gas flows on the surface facing the separator. This allows the thickness of the entire fuel cell to be reduced while ensuring the thickness of the gas diffusion layer, compared to a configuration where a groove is provided at the separator. This allows the movement of the reaction gas in the thickness direction to be controlled. Therefore, it is possible to thin the fuel cell while suppressing pressure loss at the gas diffusion layer.
(2) In the fuel cell of the above-described aspect, the groove may be formed into a rectangular shape in the cross-section of the gas diffusion layer perpendicular to a direction in which the reaction gas flows.

In the fuel cell of this aspect, the groove is formed into a rectangular shape in the cross-section of the gas diffusion layer perpendicular to a direction in which the reaction gas flows. Thus, compared to a configuration where a groove is formed into a sinusoidal wave shape, for example, it is possible to increase a contact area between the gas diffusion layer and the separator while ensuring the sectional area of the groove. As a result, even if pressure is applied in a thickness direction of the fuel cell, it is still possible to reduce application of local pressure to the gas diffusion layer, thereby reducing the occurrence of break of the fuel cell or reduction in power generation performance.
(3) In the fuel cell of the above-described aspect, the gas diffusion layer may have two portions positioned at different locations along a thickness direction of the gas diffusion layer, each of two portions having pores, wherein one portion of the two portions farther from the membrane electrode assembly than the other portion of the two portions has pores with a smaller diameter than the other portion.

In the fuel cell of this aspect, the gas diffusion layer has two portions positioned at different locations along a thickness direction of the gas diffusion layer, each of two portions having pores, wherein one portion of the two portions farther from the membrane electrode assembly than the other portion of the two portions has pores with a smaller diameter than the other portion. Thus, water present in the gas diffusion layer composed of the metal porous body that is generally hydrophilic is allowed to be discharged easily from the side closer to the membrane electrode assembly toward the side farther from the membrane electrode assembly. More specifically, in a portion in the gas diffusion layer where a pore diameter is comparatively small, a distance between metallic particles is comparatively short to cause force of attracting water to act comparatively strongly. This allows the water to be attracted toward the side in the gas diffusion layer farther from the membrane electrode assembly, thereby improving water discharge performance in the gas diffusion layer.
(4) In the fuel cell of the above-described aspect, the gas diffusion layer may have a through flow path penetrating the gas diffusion layer in the thickness direction and allowing the reaction gas to flow.

In the fuel cell of this aspect, the gas diffusion layer has the through flow path penetrating the gas diffusion layer in the thickness direction and allowing the reaction gas to flow. This allows the reaction gas to be supplied toward the membrane electrode assembly via the through flow path. Thus, even if water is present in the gas diffusion layer, it is still possible to ensure a route for the reaction gas to suppress reduction in efficiency in supplying the reaction gas.

What is claimed is:

1. A fuel cell for generating power through reaction of a reaction gas, comprising:
a membrane electrode assembly including an electrolyte membrane and a catalyst layer;
a gas diffusion layer stacked on the membrane electrode assembly and composed of a metal porous body; and
a separator having a plate shape, being parallel to a plane direction of the membrane electrode assembly, and being stacked on the gas diffusion layer, wherein
the gas diffusion layer has a groove through which the reaction gas flows on a surface facing the separator.

2. The fuel cell according to claim 1, wherein
the groove is formed into a rectangular shape in the cross-section of the gas diffusion layer perpendicular to a direction in which the reaction gas flows.

3. The fuel cell according to claim 1, wherein
the gas diffusion layer has two portions positioned at different locations along a thickness direction of the gas diffusion layer, each of two portions having pores, wherein one portion of the two portions farther from the membrane electrode assembly than the other portion of the two portions has pores with a smaller diameter than the other portion.

4. The fuel cell according to claim 1, wherein
the gas diffusion layer has a through flow path penetrating the gas diffusion layer in a thickness direction and allowing the reaction gas to flow.
